(19) United States
(12) Patent Application Publication
(10) Pub. No.: US 2009/0165248 A1
(43) Pub. Date: Jul. 2, 2009

(54) ADJUSTABLE HINGE ASSEMBLY

(75) Inventor: Jin-Xin Wang, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/191,278

(22) Filed: Aug. 13, 2008

(30) Foreign Application Priority Data
Dec. 28, 2007 (CN) 200710203540.X

(51) Int. Cl. E05D 11/08

(52) U.S. Cl. 16/339

(57) ABSTRACT

An exemplary adjustable hinge assembly (10) includes a fixing member (12), a deformable member (14), an adjustable member (18), and a rotary member (20). The deformable member is sleeved or partially sleeved on the fixing member. The deformable member and the fixing member are rotatably connected to the rotary member. The deformable member resists the fixing member and the rotary member. The adjustable member engages with the fixing member. The adjustable member is adjusted to change the maximum static frictional force between the deformable member and the rotary member.

### BACKGROUND OF THE INVENTION

1. Field of the Invention

The present invention relates generally to hinge assemblies, and particularly, to an adjustable hinge assembly.

2. Discussion of the Related Art

Hinges are usually used to rotatably connect two elements. A force or pressure is applied to one of the two elements to facilitate this relative movement. The two elements are usually able to be stable at any positions without the force or pressure so as to facilitate operating on the elements. Many electronic devices such as notebook computers have such elements.

A typical hinge used in a device having a liquid crystal display screen includes the following structures: A fixing member for connecting to a main body of the device and a hinge leaf for connecting to the display screen. The fixing member and the hinge leaf are rotatable relative to each other. An elastic member and a plurality of washers are disposed between the fixing member and hinge leaf. An elastic force of the elastic member makes the fixing member, the hinge leaf, and the washers abut to adjacent members. Frictional forces between the members are strong enough to prevent the members from rotating arbitrarily. When an external force large enough to overcome the frictional forces is applied on one of the hinge leaf, the hinge leaf can rotate relative to the fixing member.

However, the external force enabling the hinge leaf to rotate relative to the fixing member is determined by the frictional forces between the members, thus the external force can not be adjusted to meet different requirements.

Therefore, an adjustable hinge assembly which solves the above-described problems are desired.

### SUMMARY

An exemplary adjustable hinge assembly includes a fixing member, a deformable member, an adjustable member, and a rotary member. The deformable member is sleeved or partially sleeved on the fixing member. The deformable member and the fixing member are rotatably connected to the rotary member. The deformable member resists the fixing member and the rotary member. The adjustable member engages with the fixing member. The adjustable member is adjusted to change the maximum static frictional force between the deformable member and the rotary member.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present adjustable hinge assembly. Moreover, in the drawings, like reference numerals designate corresponding parts throughout the several views, and all the views are schematic.

FIG. 1 is an exploded, isometric view of an adjustable hinge assembly in accordance with a first exemplary embodiment of the present invention.

FIG. 2 is similar to FIG. 1, but viewed from another aspect.

FIG. 3 is an assembled, isometric view of the adjustable hinge assembly shown in FIG. 1.

FIG. 4 is an exploded, isometric view of an adjustable hinge assembly in accordance with a second exemplary embodiment of the present invention.

FIG. 5 is an exploded, isometric view of an adjustable hinge assembly in accordance with a third exemplary embodiment of the present invention.

FIG. 6 is a cross-sectional view of a deformable member of the adjustable hinge assembly shown in FIG. 5, taken along the line VI-VI of FIG. 5.

### DETAILED DESCRIPTION OF THE EMBODIMENTS

Reference will now be made to the drawings to describe exemplary embodiments of the present adjustable hinge assembly in detail.

The present disclosure provides an adjustable hinge assembly used in foldable electronic devices that include two components rotatably attached to each other, such as those used in personal computers (PCs), personal digital assistants (PDAs), digital cameras (DCs), and digital videos (DVs).

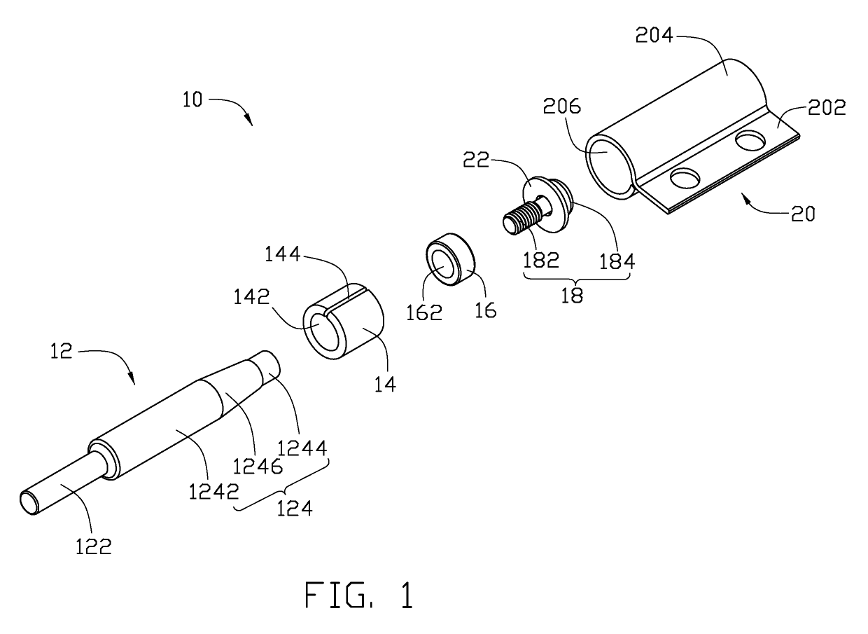

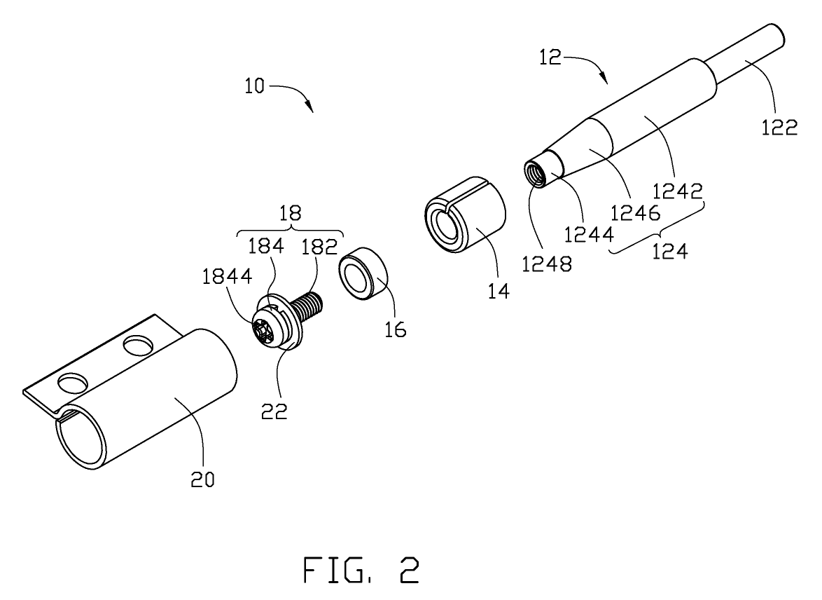

Referring to FIGS. 1 and 2, an adjustable hinge assembly 10 in accordance with a first exemplary embodiment of the present invention is shown. The adjustable hinge assembly 10 includes a fixing member 12, a deformable member 14, a cushion washer 16, an adjustable member 18, and a rotary member 20.

The fixing member 12 includes a fixing portion 122 and a connecting portion 124 extending from an end of the fixing portion 122. The fixing portion 122 is cylindrical, and is configured for fixing to a main body of a foldable electronic device. The connecting portion 124 includes a first shaft portion 1242, a second shaft portion 1244, and a third shaft portion 1246.

The first shaft portion 1242 is approximately cylindrical and extends from an end of the fixing portion 122. The second shaft portion 1244 is a hollow cylinder. An end of the second shaft portion 1244 defines a threaded hole 1248. The outer diameter of the second shaft portion 1244 is smaller than that of the first shaft portion 1242. The third shaft portion 1246 is a conical frustum, and interconnects the first shaft portion 1242 and the second shaft portion 1244. The diameter of the third shaft portion 1246 decreases along a direction away from the first shaft portion 1242.

The deformable member 14 is substantially cylindrical, and has a C-shaped cross-section. The deformable member 14 defines a circular central hole 142. A slot 144 is defined in a sidewall of the deformable member 14. The slot 144 extends through the sidewall along a direction parallel to an axis of the deformable member 14. The diameter of the central hole 142 is larger than the minimum diameter of the third shaft portion 1246, and smaller than the maximum diameter of the third shaft portion 1246. The deformable member 14 is sleeved on the third shaft portion 1246. Alternatively, the central hole 142 may be other shapes. Accordingly, a shape of the cross-section of the third shaft portion 1246 is adjusted to correspond to the central hole 142. The slot 144 may be shorter, and does not extend through the sidewall of the deformable member 14. In such cases, the deformable member 14 is made of materials with good elasticity.

The cushion washer 16 is a hollow cylinder, and defines a through hole 162. The through hole 162 is configured for receiving the second shaft portion 1244 of the fixing member 12. The cushion washer 16 is a shock absorber, and made of materials with cushion feature, such as plastic.

The adjustable member 18 is a screw including a screw portion 182 and a head 184. The screw portion 182 is configured for engaging with the threaded hole 1248 of the second shaft portion 1244. The head 184 is cylindrical, and an end surface of the head 184 defines an irregular groove 1844 for receiving a screwdriver (not shown). In use, a screwdriver is inserted into the irregular groove 1844 to rotate the adjustable member 18, so that the adjustable member 18 is screwed out or screwed into the threaded hole 1248 of the fixing member 12. The adjustable hinge assembly 10 further includes a washer 22 for being sleeved on the screw portion 182 and abutting against the head 184 and the cushion washer 16.

The rotary member 20 includes a leaf 202 and a sleeve 204 extending from an end of the leaf 202. The leaf 202 defines a pair of assembling holes (not labeled). The rotary member 20 is fixed to a cover of the foldable electronic device via the assembling holes. The sleeve 204 defines a sleeve hole 206 with the diameter slightly larger than that of the deformable member 14.

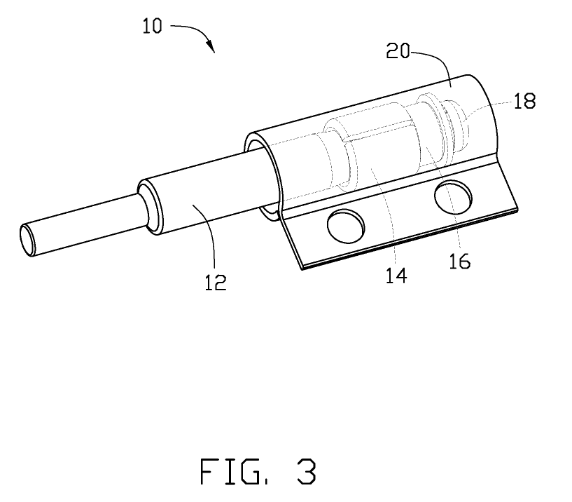

Referring also to FIG. 3, in assembling of the adjustable hinge 10, the deformable member 14 is axially sleeved on the third shaft portion 1246 of the fixing member 12. An inner surface forming the central hole 142 of the deformable member 14 resists the third shaft portion 1246, so that the diameter of the deformable member 14 can be changed as the third shaft portion 1246 slides further into or out of the central hole 142. The screw portion 182 extends through the through hole 162 of the cushion washer 16 and the washer 22. Then, the screw portion 182 engages in the threaded hole 1248 of the second shaft portion 1244. After that, the fixing member 12, together with the deformable member 14, the cushion washer 16, and the adjustable member 18, is rotatably connected to the rotary member 20 via being inserted into the sleeve hole 206 of the rotary member 20. The outer surface of the deformable member 14 resists the inner surface of the rotary member 20.

To rotate the adjustable hinge 10, an external force is applied on the rotary member 20. If the external force is large enough to overcome a frictional force between the deformable member 14 and the rotary member 20, the rotary member 20 can rotate relative to the fixing member 12. When the rotary member 20 rotates to a desired position, the external force is released. The frictional force between the deformable member 14 and the rotary member 20 prevents the rotary member 20 from further rotating. When the external force enabling the rotary member 20 to rotate relative to the fixing member 12 needs to be adjusted, the screwdriver is inserted into the irregular groove 1844 to adjust the position of the adjustable member 18. When the adjustable member 18 further screws into the threaded hole 1248, the head 184 and the washer 22 press the deformable member 14 to move towards a larger end of the third shaft portion 1246, thereby expanding the deformable member 14. Therefore, the diameter of the deformable member 14 becomes larger, and the maximum static frictional force between the deformable member 14 and the rotary member 20 increases. Thus, a larger external force should be applied to overcome a larger frictional force between the deformable member 14 and the rotary member 20 to rotate the rotary member 20. When the adjustable member 18 screws out of the threaded hole 1248, the deformable member 14 moves towards a smaller end of the third shaft portion 1246. Therefore, the diameter of the deformable member 14 becomes smaller, and the frictional force between the deformable member 14 and the rotary member 20 decreases. Thus, the external force enabling the rotary member 20 to rotate can be smaller.

It should be understood that, the cushion washer 16 and the washer 22 disposed between the deformable member 14 and the head 184 of adjustable member 18 are able to prevent an abrasion between the deformable member 14 and the adjustable member 18. As such, a service life of the adjustable hinge assembly 10 is prolonged.

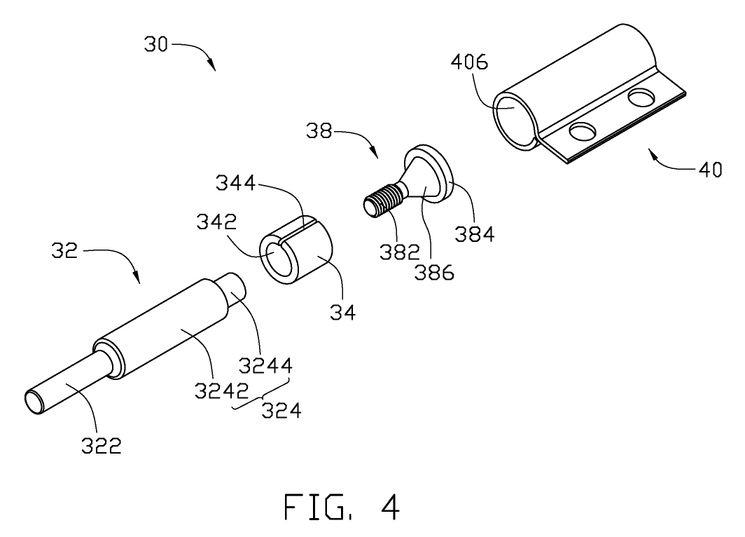

Referring to FIG. 4, an adjustable hinge assembly 30 in accordance with a second exemplary embodiment is shown. The adjustable hinge assembly 30 includes a fixing member 32, a deformable member 34, an adjustable member 38, and a rotary member 40. The adjustable hinge assembly 30 is similar in principle to the adjustable hinge assembly 10 except the following differences. Firstly, the adjustable hinge assembly 30 does not include a cushion washer. Secondly, a connecting portion 324 of the fixing member 32 does not include a conical frustum shaft portion. Thirdly, the adjustable member 38 is a screw including a screw portion 382, a head 384, and a conical frustum portion 386 interconnects the screw portion 382 and the head 384. The diameter of the conical frustum portion 386 decreases along a direction towards the screw portion 382. The diameter of the head 384 of the adjustable member 38 is larger than the maximum diameter of the deformable member 34. Fourthly, the diameter of a central hole 342 of the deformable member 34 is larger than the minimum diameter of the conical frustum portion 386, and smaller than the maximum diameter of the conical frustum portion 386.

In assembling of the adjustable hinge assembly 30, the deformable member 34 is partially sleeved on the second portion 3244 of the connecting portion 324. The inner surface for forming the central hole 342 of the deformable member 34 resists the conical frustum portion 386. The adjustable member 38 is engaged in a threaded hole of the second shaft portion 3244. Then, the fixing member 32, together with the deformable member 34 and the adjustable member 38, is rotatably connected to the rotary member 40 via being inserted into the sleeve hole 406 of the rotary member 40. The outer surface of the deformable member 34 resists the inner surface for forming the sleeve hole 406 of the rotary member 40.

In use, the adjustable member 38 is adjusted to make the screw portion 382 screw out or screw into the threaded hole of the fixing member 32. Thus, the deformable member 34 axially moves along the conical frustum portion 386, thereby expanding the deformable member 34 in a certain extent. Therefore, the maximum static frictional force between the deformable member 34 and the rotary member 40 is changed. Thus, an external force should be applied to overcome a larger or a smaller frictional force between the deformable member 34 and the rotary member 40 to rotate the rotary member 40. The external force enabling the rotary member 40 to rotate is adjusted.

Alternatively, the second shaft portion 3244 of the fixing member 32 may be omitted. In such cases, an end of the first shaft portion 3242 defines a threaded hole, and the adjustable member 38 is longer. The screw portion 382 of the adjustable member 38 is engaged with the first shaft portion 3242 of the fixing member 32 after inserting through the central hole 342 of the deformable member 34. Two ends of the deformable member 34 abut against the end surface of the first shaft portion 3242 and the conical frustum portion 386 correspondingly. The inner surface for forming the central hole 342 resists the conical frustum portion 386 of the adjustable member 38.

In alternative embodiments, the conical frustum portion 386 may be omitted. In such cases, the deformable member 34 is made of materials with good elasticity, such as rubber. A slot 344 of the deformable member 34 may also be omitted. In assembly, two ends of the deformable member 34 respectively abut against the first shaft portion 3242 and the head 384 of the adjustable member 38. When the adjustable member 38 is adjusted to move relative to the fixing member 32, the adjustable member 38 presses the deformable member 34 to deform. Thus, the diameter of a cross-section of the deformable member 34 is changed, thereby changing the maximum static frictional force between the outer surface of the deformable member 34 and the inner surface for forming the sleeve hole 406 of the rotary member 40. The external force for rotating the rotary member 40 is thus adjusted.

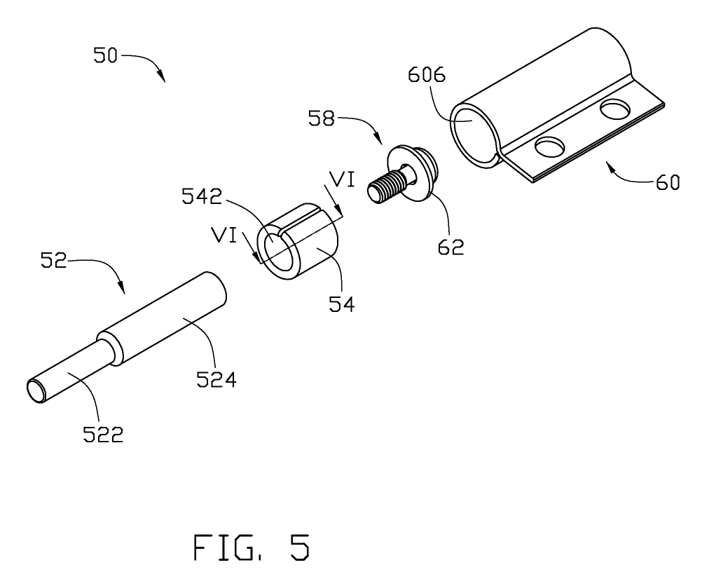

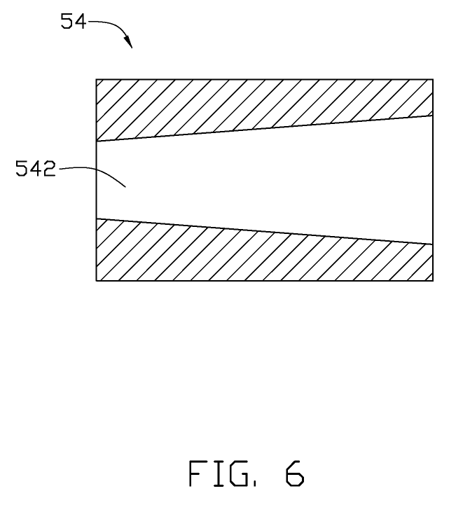

Referring to FIG. 5, an adjustable hinge assembly 50 in accordance with a third exemplary embodiment is shown. The adjustable hinge assembly 50 includes a fixing member 52, a deformable member 54, an adjustable member 58, and a rotary member 60. The fixing member 52 includes a fixing portion 522 and a connecting portion 524 extending from an end of the fixing portion 522. The adjustable hinge assembly 50 is similar in principle to the adjustable hinge assembly 10 except the following differences. Firstly, the connecting portion 524 of the fixing member 52 is a cylinder, and defines a threaded hole at an end thereof. Secondly, the diameter of a washer 62 is larger than the maximum diameter of the deformable member 54. Thirdly, referring also to FIG. 6, the diameter of a central hole 542 decreases along the axis of the deformable member 54. The diameter of the connecting portion 524 is larger than the minimum diameter of the central hole 542, and smaller than the maximum diameter of the central hole 542.

In assembly, the connecting portion 524 of the fixing member 52 is inserted into the central hole 542, with the deformable member 54 partially sleeved on the connecting portion 524. The connecting portion 524 resists the inner surface for forming the central hole 542. Then, a screw portion (not labeled) of the adjustable member 58 is engaged in a thread hole (not labeled) of the connecting portion 524. After that, the fixing member 52, together with the deformable member 54 and the adjustable member 58, is rotatably connected to the rotary member 60 via being inserted into the sleeve hole 606 of the rotary member 60. The outer surface of the deformable member 54 resists the inner surface for forming the sleeve hole 606.

In use, the adjustable member 58 is adjusted to make the deformable member 54 axially move along the connecting portion 524. The connecting portion 524 resists the deformable member 54, thereby expanding the deformable member 54 to a certain extent. The maximum static frictional force between the deformable member 54 and the rotary member 60 is adjusted. Thus, an external force for rotating the rotary member 54 is adjusted.

The deformable members 14, 34, 54 of the adjustable hinge assemblies 10, 30, 50 are detached parts. The deformable members 14, 34, 54 may be easily replaced after being worn out, so that there is no need for changing the whole adjustable hinge assemblies 10, 30, 50.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An adjustable hinge assembly, comprising:
a fixing member;
a rotary member;
a deformable member sleeved or partially sleeved on the fixing member, the deformable member and the fixing member being rotatably connected to the rotary member, the deformable member being resisting the fixing member and the rotary member; and
an adjustable member engaged with the fixing member, the adjustable member being capable of adjusting the deformable member to resist the fixing member and the rotary member to different extent.

2. The adjustable hinge assembly as claimed in claim 1, wherein a slot is defined in a sidewall of the deformable member.

3. The adjustable hinge assembly as claimed in claim 2, wherein the fixing member includes a connecting portion, the connecting portion includes a conical frustum portion and a second shaft portion, and the deformable member is sleeved on the conical frustum portion.

4. The adjustable hinge assembly as claimed in claim 3, wherein the second shaft portion of the connecting portion defines a threaded hole at one end thereof, the adjustable member is a screw including a screw portion, the screw portion is engaged in the threaded hole of the second shaft portion.

5. The adjustable hinge assembly as claimed in claim 1, wherein the fixing member is substantially elongated cylindrical shape and includes a connecting portion, the connecting portion includes a first shaft portion and a second shaft portion, the diameter of the first shaft portion is larger than that of the second shaft portion, and the deformable member is partially sleeved on the second shaft portion.

6. The adjustable hinge assembly as claimed in claim 5, wherein the second shaft portion defines a threaded hole at one end thereof, the adjustable member is a screw including a screw portion and a head, a conical frustum portion interconnects the screw portion and the head, the diameter of the conical frustum portion decreases along a direction towards the screw portion, and the screw portion is engaged in the threaded hole of the second shaft portion.

7. The adjustable hinge assembly as claimed in claim 6, wherein the deformable member is partially sleeved on the conical frustum portion of the adjustable member, the deformable member resists the first shaft portion of the fixing member and the conical frustum portion, and the conical frustum portion is configured for expanding the deformable member to a certain extent.

8. The adjustable hinge assembly as claimed in claim 1, wherein the deformable member defines a central hole, the diameter of the central hole decreases along the axis of the deformable member.

9. The adjustable hinge assembly as claimed in claim 8, wherein the fixing member includes a connecting portion, and the connecting portion defines a threaded hole at one end thereof, the deformable member is partially sleeved on the connecting portion, the adjustable member is engaged in the threaded hole of the connecting portion, and the deformable member resists the connecting portion and is axially moved along the connecting portion.

10. An adjustable hinge assembly, comprising:
a fixing member including a conical frustum portion;
a rotary member;
a deformable member defining a through hole engaged with the conical frustum portion of the fixing member, the deformable member and the fixing member rotatably connected to the rotary member, the deformable member resisting the fixing member and the rotary member; and
an adjustable member engaged with the fixing member, the adjustable member being capable of making the deformable member axially move along the conical frustum portion.

11. The adjustable hinge assembly as claimed in claim 10, wherein a slot is defined in a sidewall of the deformable member.

12. The adjustable hinge assembly as claimed in claim 11, further comprising a cushion washer, the cushion washer being placed over the fixing member and disposed between the deformable member and the adjustable member.

13. The adjustable hinge assembly as claimed in claim 12, wherein the fixing member includes and a conical frustum portion and a second shaft portion, the diameter of the conical frustum portion decreases along a direction towards the second shaft portion, and the cushion washer is placed over the second shaft portion.

14. The adjustable hinge assembly as claimed in claim 13, wherein the adjustable member is a screw including a screw portion and a head, the second shaft portion defines a threaded hole at one end thereof, and the screw portion is engaged in the threaded hole.

15. The adjustable hinge assembly as claimed in claim 14, further comprising a washer placed over the screw portion, two ends of the cushion washer resisting the deformable member and the head portion respectively, and the screw portion being engaged in the threaded hole of the second shaft portion.
